(19) United States
(12) Patent Application Publication
(10) Pub. No.: US 2014/0159988 A1
(43) Pub. Date: Jun. 12, 2014

(54) ENHANCED TRANSMISSION-ENERGY MATERIAL AND METHOD FOR MANUFACTURING THE SAME

(71) Applicants: David Cordova, Laytonsville, MD (US); Eelco Van Oosterbosch, Tilburg (NL)

(72) Inventors: David Cordova, Laytonsville, MD (US); Eelco Van Oosterbosch, Tilburg (NL)

(73) Assignee: DSM IP Assets B.V., Heerlen (NL)

(21) Appl. No.: 13/985,186

(22) PCT Filed: Feb. 17, 2011
(86) PCT No.: PCT/EP2011/052344

§ 371 Date: Feb. 26, 2014

(51) Int. Cl. H01Q 1/42; D03D 1/00; D06N 3/12; D06N 3/00

(52) U.S. Cl. CPC H01Q 1/42; D06N 3/0006; D03D 1/0088; D06N 3/12; D06N 3/0038
USPC 343/872; 442/170; 442/186; 442/64

(57) ABSTRACT

The invention relates to a low dielectric loss material comprising a plurality of polyolefin tapes forming a sheet and a coating disposed onto said sheet, wherein said coating comprises an epoxy resin.

The invention relates to an enhanced transmission-energy material having an ultra low dielectric loss comprising a plurality of polyolefin tapes for use in electrical applications in electrical applications such as circuit boards, insulators, electronic packages, antennas, radar absorbent material/structure (RAM/RAS) systems, wireless devices or housings, radomes and the like. The invention also relates to a method of manufacturing said material.

Such a material is known for example from U.S. Pat. No. 7,648,758 disclosing a composite material including a polymeric matrix and reinforcement fibers contained within the polymeric matrix. Reinforcement fibers used therein include glass fibers, quartz fibers, carbon fibers, ultra high molecular weight polyethylene (UHMWPE) fibers, high modulus polypropylene (HMPP) fibers, fluorocarbon-based fibers such as polytetrafluoroethylene (PTFE) fibers, polyaramid fibers such as poly-paraphenylene terephthalamide fibers, combinations of reinforcement fibers, high strength metal fibers and the like. The fibers can be formed into a fabric such as, nonwoven, a woven or a knitted fabric. According to this publication, the term fiber also includes tape fibers.

While have been improvements in materials for use in electrical applications, there remains room for further improvement and variation within the art.

In one embodiment the invention provides a low dielectric loss material comprising a plurality of polyolefin tapes forming a sheet and a coating disposed onto said sheet, wherein said coating comprises an epoxy resin.

It was observed that the material of the invention has unmatched electrical properties. In particular it was observed that the material of the invention has a high transparency to high frequency waves over a large bandwidth, e.g. 1 GH to 110 GHz, said transparency being never achieved hitherto in the art. More in particular the material of the invention has a low dielectric loss.

Hereinafter, the invention will be explained more in detail with the help of preferred embodiments.

Preferably, the tapes used according to the invention have a width of at least 2 mm, more preferably at least 5 mm, most preferably at least 10 mm. It was observed that wider tapes perform better when used in the material of the invention. Although only limited by practicalities, said tapes have a width of preferably at most 400 mm, more preferably at most 300 mm, most preferably at most 200 mm.

Preferably, said tapes have an areal density of between 5 and 200 gm², more preferably between 8 and 120 gm², most preferably between 10 and 80 gm². The areal density of a tape can be determined by weighing a conveniently cut surface from the tape. It was observed that a material of the invention comprising such tapes has improved properties.

Preferably, said tapes have an average thickness of at most 120 μm, more preferably at most 50 μm, and most preferably between 5 and 29 μm. The average thickness can be measured e.g. with a microscope on different cross-sections of the tape and averaging the results.

Suitable polyolefins to be used according to the invention in manufacturing tapes are in particular homopolymers and copolymers of ethylene and propylene, which may also contain small quantities of one or more other polymers, in particular other alkene-1-polymers.

Particularly good results are obtained if linear polyethylene (PE) is selected as the polyolefin. Linear polyethylene is herein understood to mean polyethylene with less than 1 side chain per 100 C atoms, and preferably with less than 1 side chain per 300 C atoms; a side chain or branch generally containing at least 10 C atoms. Side chains may suitably be measured by FTIR on a 2 mm thick compression moulded film, as mentioned in e.g. EP 0269151. The linear polyethylene may further contain up to 5 mol % of one or more other alkenes that are copolymerisable therewith, such as propene, butene, pentene, 4-methylpentene, octene. Preferably, the linear polyethylene is of high molar mass with an intrinsic viscosity (IV, as determined on solutions in decalin at 135° C.) of at least 4 dlg; more preferably of at least 8 dlg. Such polyethylene is also referred to as ultra-high molar mass polyethylene. Intrinsic viscosity is a measure for molecular weight that can more easily be determined than actual molar mass parameters like Mn and Mw. There are several empirical relations between IV and Mw, but such relation is highly dependent on molecular weight distribution. Based on the equation Mw=5.37×10⁴ [IV]1.37 (see EP 0504954 A1) an IV of 4 or 8 dlg would be equivalent to Mw of about 360 or 930 kg/mol, respectively.

The tapes may be also prepared by feeding a polymeric powder between a combination of endless belts, compression-moulding the polymeric powder at a temperature below the melting point, also referred to as the melting temperature, thereof and rolling the resultant compression-moulded polymer followed by drawing. Such a process is for instance described in EP 0 733 460 A2, which is incorporated herein by reference. Compression moulding may also be carried out by temporarily retaining the polymer powder between the endless belts while conveying them. This may for instance be done by providing pressing platens and/or rollers in connection with the endless belts. Preferably UHMWPE is used in this process. This UHMWPE needs to be drawable in the solid state.

Another preferred process for the formation of tapes comprises feeding a polymer to an extruder, extruding a tape at a temperature above the melting point thereof and drawing the extruded polymer tape. Preferably the polyethylene tapes are prepared by a gel process. A suitable gel spinning process is described in for example GB-A-2042414, GB-A-2051667, EP 0205960 A and WO 0173173 A1, and in “Advanced Fibre Spinning Technology”, Ed. T. Nakajima, Woodhead Publ. Ltd (1994), ISBN 185573 182 7. Such processes can be easily modified to produce tapes by using a slit extrusion die. In short, the gel spinning process comprises preparing a solution of a polyolefin of high intrinsic viscosity, extruding the solution into a tape at a temperature above the dissolving temperature, cooling down the tape below a gelling temperature, thereby at least partly gelling the tape, and drawing the tape before, during and/or after at least partial removal of the solvent.

Drawing, preferably uniaxial drawing, of the produced tape may be carried out by means known in the art. Such means comprise extrusion stretching and tensile stretching on suitable drawing units. To attain increased mechanical strength and stiffness, drawing may be carried out in multiple steps. In case of the preferred ultra high molecular weight polyethylene tapes, drawing is typically carried out uniaxially in a number of drawing steps. The first drawing step may for instance comprise drawing to a stretch factor of 3. In case that the polyolefin is UHMWPE, a multiple drawing process is preferably used where the tapes are stretched with a factor of 9 for drawing temperatures up to 120° C., a stretch factor of 25 for drawing temperatures up to 140° C., and a stretch factor of 50 for drawing temperatures up to and above 150° C. By multiple drawing at increasing temperatures, stretch factors of about 50 and more may be reached. This results in high strength tapes, whereby for tapes of ultra high molecular weight polyethylene, a strength range of 1.2 GPa to 3 GPa may easily be obtained.

The resulting drawn tapes may be used as such or they may be cut to their desired width, or split along the direction of drawing. For UHMWPE tapes, the areal density is preferably less than 50 gm² and more preferably less than 29 gm² or 25 gm².

Preferably the tapes have a tensile strength of at least 0.3 GPa, more preferably at least 0.5 GPa, even more preferably at least 1 GPa, most preferably at least 1.5 GPa.

According to the invention, the material comprises a plurality of polyolefin tapes forming a sheet.

In a preferred embodiment, said sheet is a multilayered sheet comprising a plurality of monolayers containing tapes. In a more preferred embodiment, said sheet is a multilayered sheet consisting essentially of a plurality of monolayers, said monolayers consisting essentially of polyolefin tapes. In the most preferred embodiment, said sheet is a multilayered sheet consisting of a plurality of monolayers, said monolayers consisting of polyolefin tapes.

Preferably the monolayers are obtained by weaving the tapes. Weaving of tapes is known per se, for instance from WO2006075961, the content of which is incorporated herein by reference. WO2006075961 describes a method for producing a woven monolayer from tape-like warps and wefts comprising the steps of feeding tape-like warps to aid shed formation and fabric take-up; inserting tape-like weft in the shed formed by said warps; depositing the inserted tape-like weft at the fabric-fell; and taking-up the produced woven monolayer; wherein said step of inserting the tape-like weft involves gripping a weft tape in an essentially flat condition by means of clamping, and pulling it through the shed. The inserted weft tape is preferably cut off from its supply source at a predetermined position before being deposited at the fabric-fell position. When weaving tapes specially designed weaving elements are used. Particularly suitable weaving elements are described in U.S. Pat. No. 6,450,208, the content of which is also incorporated in the present application by reference. Preferably, the woven structure of said monolayer is a plain weave. Preferably the weft direction in a monolayer in the sheet is under an angle with the weft direction in an adjacent monolayer. Preferably said angle is about 90°.

In another embodiment, the sheet comprised by the material of the invention is a multilayered sheet comprising a plurality of monolayers, said monolayers contain an array of unidirectionally arranged tapes, i.e. tapes running along a common direction. Preferably, the tapes partially overlap along their length. Preferably, the common direction of the tapes in a monolayer is under an angle with the common direction of the tapes in an adjacent monolayer. Preferably said angle is about 90°.

Excellent results were obtained when the tapes were subjected to pressure, preferably at a temperature below the melting temperature (Tm) of the polyolefin as determined by DSC, to form a consolidated sheet. When the tapes were arranged into monolayers, preferably the consolidated sheet was obtained by pressing a plurality of the monolayers at increased pressures, preferably at a temperature below Tm. Useful pressures were pressures of at least 50 bar, more preferably of at least 75 ar, most preferably of at least 100 bar. The temperature used was preferably of between 120° C. below Tm and Tm, more preferably between 50 degrees below Tm and 2 degrees below Tm. Suitable temperatures when UHMWPE tapes are use, are between 30° C. and 150° C., more preferably between 30° C. and 120° C.

The thickness of the sheet can be chosen within wide ranges and depends by the purpose of the material of the invention. Preferably, the thickness of said sheet is between 1 mm and 100 mm, more preferably between 1 mm and 10 mm, most preferably between 1 mm and 5 mm. It was observed that such thin sheets have excellent electrical properties and being also lightweight.

Preferably, the sheet is free of any matrix, binder, impregnated component or any other component that is usually used in the art to bind the tapes or monolayers forming said sheet together. It was observed that for a sheet free of matrix and/or binder the electrical properties of the material of the invention were improved.

According to the invention, a coating is disposed onto the sheet contained by the material of the invention, wherein said coating comprises an epoxy resin.

The coatings are disposed onto said surface starting from a coating formulation based on the epoxy resin. Suitable epoxy resins to be used in forming said coating formulation are for example those comprising epoxy monomer or resin in amounts of from about 20% by weight to about 95% by weight, based on the total weight of the coating formulation. Preferably, from about 30% by weight to about 70% by weight epoxy monomer may be included in a curable coating formulation. Epoxy resins may be used including the EPON Resins from Shell Chemical Company, Houston, Tex., for example, EPON Resins 1001F, 1002F, 1007F and 1009F, as well as the 2000 series powdered EPON Resins, for example, EPON Resins 2002, 2003, 2004 and 2005. Preferably, the epoxy monomer or resin has a high crosslink density, a functionality of about 3 or greater, and an epoxy equivalent weight of less than 250. Exemplary epoxies which may be employed according to embodiments of the invention include The Dow Chemical Company (Midland, Mich.) epoxy novolac resins D.E.N. 431, D.E.N. 438 and D.E.N. 439.

A curing agent for the epoxy may also be added in amounts of from about 1% by weight to about 10% by weight of the epoxy component. The curing agent may be a catalyst or a reactant, for example, the reactant dicyandiamide. From about 1% by weight to about 50% by weight epoxy solvent, based on the weight of the coating formulation, may also be included in the coating formulations. Epoxy solvents can be added to liquify the epoxy monomer or resin or adjust the viscosity thereof. Preferred epoxy solvents are triethylphosphate and ethylene glycol. A separate epoxy solvent may not be needed according to some embodiments of the invention wherein the epoxy is liquid at room temperature or wherein a fluorinated monomer or surfactant component of the coating formulation acts as a solvent for the epoxy.

Exemplary waterborne epoxy resins which may be used in aqueous suspension coating formulations include the EPI-REZ Resins from Shell Chemical Company, for example, the EPI-REZ Resins WD-510, WD-511, WD-512,3510-W-60,3515-W-60,3519-W-50,3520-WY-55 and 3522-W-60. The coating composition may comprise microparticles, microfibers, foaming and/or pore-forming agents, and may be dried, cured, and/or hardened so as to produce sufficient surface roughness to provide high contact angles to water. However, it is preferred that the coating composition is free of such components.

Further commercially available examples of epoxy resins used in the coating formulation include MIL-PRF-22750F; MIL-PRF-22750F; MIL-P-53022C Type II, E90Y203 (Type I, Class C2 , 2.8 VOC); MIL-P-53022B, E90G204 (Type II, Class I); MIL-P-53022B; MIL-P- 23377G, e.g. E90G203 (Type I, Class C2 , 2.8 VOC); and MIL-P-53022.

Other suitable epoxy resins used in the coating formulation may include liquid epoxy esters as proposed by C. K. Thorstad, “Emulsions—Why and How They are Used”, Modern Plastics, July 1959, pp. 83-84, in compositions containing either water or the epoxy ester itself as a vehicle, together with polyvinylacetate, polyacrylic, or poly(butadienestyrene) lattices. Acid curing agents, for example dimethyl acid pyrophosphate or boron trifluoride are cited for these applications.

The epoxy resin used according to the invention has preferably a dielectric constant of at most 6.0, more preferably of at most 3.0, most preferably of at most 2.2. Preferably said dielectric constant of said epoxy resin is between 2.2 and 2.5, more preferably between 2.20 and 2.22. The dielectric constant and dielectric loss of the epoxy resin can be routinely measured with an electromagnetic transmission line positioned into an electromagnetic noise free room using a coaxial probe. Preferably the dielectric loss of said epoxy resin is at most 0.025, more preferably at most 0.0001. Preferably, said dielectric constant is between 0.0001 and 0.0005.

The coating disposed onto the sheet contained by the material of the invention has a thickness of preferably between 1 and 6 μm, more preferably between 1 and 4 μm, most preferably between 1 and 2 μm. The coating may be applied by usual methods in the art, e.g. by spraying, dipping or blade coating the sheet contained by the material of the invention. Said coating may be disposed on one or both of the surfaces of said sheet.

The adhesion of the coating to the sheet can be enhanced by via subjecting said sheet to corona treatment and/or plasma treatment

Preferably, the surface of the sheet contained by the material of the invention onto which the coating is disposed is primed before the disposal of said coating. It was observed that by priming the surface of said sheet, the adhesion of the coating was further improved.

In one embodiment the invention relates to a low transmission-energy-loss material comprising a plurality of polyolefin tapes forming a sheet, said sheet containing at least one primed surface, said at least one primed surface being primed with a primer comprising a thermosetting resin, wherein a coating is disposed onto said primed surface of said sheet, wherein said coating comprises an epoxy resin.

Primers for use according to the invention may be applied by e.g.

spraying solutions containing one or two component thermosetting resins diluted to sprayable levels with suitable organic solvents. The primers may also be applied starting from emulsions of thermosetting resin, said emulsions preferably containing one or more emulsified liquid epoxy resins dispersed in an aqueous dispersing phase containing an alkali and acid stable non-ionic emulsifying agent and a water-dispersible binding colloid. For those applications where curing agents are also required, the curing agent is dissolved into the epoxy resin prior to dispersion. Such emulsions are known for example from U.S. Pat. No. 2,872,427 included herein by reference. Other suitable primers such as aqueous epoxy resin dispersions containing preferably chromium trioxide and phosphoric acid are disclosed in U.S. Pat. No. 5,001,173 included herein by reference. In the article “Guidelines to Formulation of Waterborne Epoxy Primers”, M. A. Jackson, Polymer Paint Colour Journal 180 (4270) (1990) at pages 608-621, included herein by reference, are described two component primer systems containing as one component an epoxy resin dispersion in water and solvent together with various corrosion inhibitors, and as the second component, a water reducible amine catalyst in water. In the article “Waterborne Epoxy Dispersions Provide Compliant Alternatives”, R. Buehner et. al., Adhesives Age, December 1991, included herein by reference, are described waterborne liquid and solid epoxy resin dispersions cured with dicyandiamide and water soluble 2-methylimidazole catalyst for use as adhesives.

Excellent results were obtained when the primer was a one-component aqueous adhesive primer which contains little or no volatile organic compounds (VOCs). The most preferred aqueous adhesive primer is an aqueous, non-ionic solid epoxy resin dispersion which contain as a distinct phase a solid epoxy curing agent, preferably in the substantial absence of any protective colloid. Examples of such primers are known from U.S. Pat. No. 5,576,061 the entire content of which is included herein by reference. Commercial examples of such primers include MIL-PRF-22750F; MIL-PRF-22750F; MIL-P-53022C Type II, E90Y203 (Type I, Class C2 , 2.8 VOC); MIL-P-53022B, E90G204 (Type II, Class I); MIL-P-53022B; MIL-P-23377G, e.g. E90G203 (Type I, Class C2 , 2.8 VOC); and MIL-P-53022.

The epoxy resins used in the formulation of the aqueous adhesive primers utilized in accordance with the invention, said epoxy resins being hereinafter simply referred to as epoxy primers, are preferably conventional solid epoxy resins having functionalities of about 1.8 or more, preferably 2 or more, containing substantially no ionic or ester groups, as described in Epoxy Resins. Lee and Neville, McGraw-Hill, chapters 1 to 4, included herein by reference. Preferred epoxy primers are the optionally chain-extended, solid glycidyl ethers of phenols such as resorcinol and the bisphenols, e.g. bisphenol A, bisphenol F, and the like. Also suitable are the solid glycidyl derivatives of aromatic amines and aminophenols, such as N,N,N′,N′-tetraglycidyl-4,4′-diaminodiphenylmethane. Preferred are the solid novolac epoxy primers and solid DGEBA primers. The epoxy primers must be solids themselves, or produce solid compositions when admixed with other epoxies.

Examples of suitable commercial epoxy primers are Epi-Rez™ SU-8, a polymeric epoxy resin with an average functionality of about 8, melting point (Durran's) of 82° C., and an epoxy equivalent weight of 215 available from Rhone-Poulenc; DER 669, a high molecular weight solid epoxy resin having a Durran's softening point of 135° -155° C. and an epoxy equivalent weight of 3500-5500 available from the Dow Chemical Company; Epi-Rez™ 522-C, a solid DBEGA epoxy having an epoxy equivalent weight of 550-650 and a Durran's melting point of 75° -85° C., available from Rhone-Poulenc; and ECN 1273, 1280, and 1299 orthocresolformaldehyde novolac solid epoxy resins having epoxy functionalities of from 3.8 to 5.4, epoxy equivalent weights of from 225 to 235, and melting points of from 73° -99° C., available from Ciba-Geigy. These primers may be supplied in solid form and ground to the correct particle size, or as an aqueous dispersion. For example, ECN-1299 is available as an aqueous dispersion from Ciba-Geigy as ECN-1440, and Epi-Rez™ 522C from Rhone-Poulenc as 35201 epoxy dispersion.

Preferably, the aqueous adhesive primers utilized in accordance with the invention comprises from 40 to about 10 percent by weight of a dispersed phased containing the epoxy primer, and from 60 to about 90 percent by weight of an aqueous continuous phase. The epoxy primer dispersed phase may comprise a dispersion of more than one epoxy resin as a mixture of distinct particles, or may consist of only one type of particle containing more than one epoxy resin. Thus a flexibilizing epoxy such as the higher molecular weight bisphenol A or bisphenol F epoxies may be blended with a highly temperature resistant epoxy such as TGMDA and the mixture cooled, ground, or otherwise dispersed into solid particles of the requisite size. These same epoxy resins might be advantageously dispersed separately without blending.

As indicated above, mixtures of epoxy resins are also suitable as epoxy primers. A preferred mixture comprises a solid epoxy resin having a functionality of about 5.5 or less, and a solid epoxy resin having a functionality of about 6 or more. The use of higher functionality epoxy resins, i.e. epoxy resins having a functionality of five or more, in minor amounts is preferred, for examples less than 40 weight percent based on the sum of the weights of all epoxy resins in the composition. The use of such higher functionality epoxy resins in such minor amounts has been unexpectedly found to increase the solvent resistance of the cured primer without lowering adhesive properties substantially. A preferred high functionality epoxy resin is Epi-Rez™SU-8, a polymeric solid epoxy resin having an average functionality of eight.

Especially preferred is a mixture of:
1) from 30 to 70 weight percent of a solid epoxy resin having a functionality of from about 1.8 to about 4 and an epoxy equivalent weight of from about 400 to about 800;
2) from 5 to 20 weight percent of a solid epoxy resin having a functionality of from about 1.8 to about 4 and an epoxy equivalent weight of from about 2000 to about 8000; and
3) from 10 to 40 weight percent of a solid epoxy resin having a functionality of about 5 or more and having an epoxy equivalent weight of from about 100 to about 400,
   the weight percents totalling 100 percent based on total weight of the epoxy mixture.

Suitable curing agents for the epoxy primers used in accordance with the invention are preferably substantially water insoluble, and are preferably solid at room temperature. Examples of such curing agents are aromatic amine curing agents such as 4,4′-diaminodiphenylmethane, and in particular, 3,3′- and 4,4′-diaminodiphenylsulfone. Further suitable are 3,3′- and 4,4′-diaminodiphenyloxide, 3,3- and 4,4′-diaminodiphenyloxide, 3,3′- and 4,4′-diaminodiphenylsulfide, and 3,3′- and 4,4′-diaminodiphenylketone. Most preferred as a curing agent is 4,4′-[1,4-phenylene(1-methylethylidene)]-bis(benzeneamine). Also suitable are the amino and hydroxyl terminated polyarylene oligomers wherein the repeating phenyl groups are separated by ether, sulfide, carbonyl, sulfone, carbonate, or like groups. Examples of such curing agents are the amino-and hydroxyl-terminated polyarylenesulfones, polyaryleneethersulfones, polyetherketones, polyetheretherketones, and like variants.

Other suitable solid diamine curing agents include 2,4-toluenediamine, 1,4-phenylenediamine, 2,2-bis(4-aminophenyl)hexafluoropropane, 2,2-bis(3-amino-4-hydroxyphenyl)hexafluoropropane, 3,4′-diaminodiphenyloxide, 9,9-bis(4-aminophenyl)fluorene, o-toluidine sulfone, and 4,4′-diaminobenzanilide. Particularly also preferred are 9,10-bis(4-aminophenyl)anthracene, 2,2-bis(4-[3-aminophenoxy]phenyl)sulfone, 2,2-bis(4-[4-aminophenoxy]phenyl)sulfone, 1,4-bis(4-aminophenoxy)biphenyl, bis(4-[4-aminophenoxy)phenyl)ether, 2,2-bis(4-[4-aminophenoxy]phenyl)propane, and 2,2-bis([4-(4-amino-2-trifluorophenoxy)]phenyl)hexafluoropropane. Most preferably, those solid amine curing agents having melting points below 250° F., preferably below 220° F. are utilized.

Catalysts are generally unnecessary for the epoxy primers; however, solid, water dispersible catalysts may be added when the particular curing agent is not sufficiently active at the primer bake temperature to effect cure of the epoxy primer. The catalyst should be substantially water insoluble, and in particulate form having a particle size such that essentially 100 percent of the particles have mean diameters less than about 30 μm.

The presence of volatile organic solvents in the epoxy primers used in accordance with the invention is undesirable and generally unnecessary. However, it would not depart from the spirit of the invention to employ a most minor portion of such a solvent, i.e. less than 1-2% by weight. Examples of volatile organic solvents which could be added without affecting the function and physical properties of the composition include the low molecular weight glycols and glycol ethers, N-methylpyrrolidone, and similar solvents. By the term “substantially solvent free” is meant that the system contains no volatile organic solvent or such a minor portion that substantially no advantage or difference can be ascertained between the cured physical properties obtained from the completely solventless system and the system containing the minor amount of solvent.

The epoxy primer may also contain dyes, pigments, leveling agents, additional dispersing agents, thickeners, and the like, however it is preferred that the epoxy primer is free of these compounds.

The one-component aqueous adhesive primer may be applied by traditional methods, for example by air driven or airless spray guns, by high volume low pressure spray guns, and the like, for example a Binks model 66 spray gun. Following drying, the finish is baked at a temperatures sufficient to the cure the coating, most preferably at about 115°-125° C. Cure time is dependent upon cure temperature and can be, for example from about 0.5 to about 4 hours. Preferably, the epoxy primer is cured at about 120° C. for one hour.

Nominal cured coating thicknesses for the primer used in accordance with the invention are from 0.02 to 1.0 mils (0.5 to 25.4 μm), preferably from 0.05 to 0.5 mils (1.3 to 12.7 μm), and especially from 0.05 to 0.25 mils (1.3 to 6.4 μm). Surprisingly, even though the epoxy primer and curing agent are in distinct phases, the coatings produced are of exceptionally high quality.

Once the epoxy primer has been applied to the sheet contained by the material of the invention, the coating containing the epoxy resin can be adhered to the so-primed sheet in a normal manner, e.g. by applying a crosslinkable epoxy resin onto the primed surface of said sheet, then curing the crosslinkable epoxy resin.

In an embodiment of the invention, the epoxy resin contained by the coating formulation and the epoxy resin contained by the primer are the same. .

The invention also relates to a method of producing the material of the invention, said method comprising the steps of:
a) providing a plurality of monolayers comprising polyolefin tapes;
b) stacking said plurality of monolayers;
c) forming a consolidated sheet by compressing said plurality of monolayers under a pressure of at least 50 bar and at a temperature between room temperature and the melting temperature of the polyolefin tapes as measured by DSC on unconstrained tapes;
d) optionally priming at least one surface of said consolidated sheet, said surface being the surface intended for subsequent coating, with a primer comprising a thermosetting resin, preferably a one-component aqueous adhesive primer which contains little or no volatile organic compounds;
e) coating at least one surface of said sheet with a coating comprising an epoxy resin.

The invention relates further to various products comprising the material of the invention said products including circuit boards, insulators, electronic packages, antennas, RAM/RAS systems, wireless devices or housings, radomes and the like.

In particular the invention relates to a radome comprising the material of the invention. The term “radome,” which is a portmanteau word derived from the words radar and dome, originally referred to radar-transparent, dome-shaped structures that protected radar antennas on aircraft. Over time, its meaning has expanded to encompass almost any structure that protects a device, such as a radar antenna, that sends or receives electromagnetic radiation, such as that generated by radar, and is substantially transparent to the electromagnetic radiation. A radome can be flat, ogival, etc.; it is preferred to be dome-shaped. Radomes are found on aircraft, vehicles, sea-faring vessels, and on the ground.

The invention also relates to an assembly comprising the radome of the invention and a high frequency (1 GHz to 110 GHz) pulsed antenna. It was observed that for such an assembly, the radome minimally influences the transmission and/or reception of said antenna. The invention relates more in particular to an assembly comprising a high frequency antenna emitting and/or receiving a high frequency electromagnetic radiation and an antenna housing comprising walls and an opening to allow at least part of the electromagnetic radiation to be received and/or emitted by said antenna without interference with said walls wherein said opening is at least partially covered by the material of the invention. The invention will be further explained with the help of the following example and comparative experiment:

### Production of Tape

An ultrahigh molecular weight polyethylene with an intrinsic viscosity of 20 was mixed to become a 7 wt % suspension with decalin. The suspension was fed to an extruder and mixed at a temperature of 170° C. to produce a homogeneous gel. The gel was then fed through a slot die with a width of 600 mm and a thickness of 800 μm. After being extruded through the slot die, the gel was quenched in a water bath, thus creating a gel-tape. The gel tape was stretched by a factor of 3.8 after which the tape was dried in an oven consisting of two parts at 50° C. and 80° C. until the amount of decalin was below 1%. This dry gel tape was subsequently stretched in an oven at 140° C., with a stretching ratio of 5.8, followed by a second stretching step at an oven temperature of 150° C. to achieve an final thickness of 18 micrometer. The width of the tapes was 0.1 m and their tensile strength 440 MPa.

The tensile properties of the tape were tested by twisting the tape at a frequency of 38 twists/meter to form a narrow structure that is tested as for a normal yarn. Further testing was in accordance with ASTM D885M, using a nominal gauge length of the fibre of 500 mm, a crosshead speed of 50%/min and Instron 2714 clamps, of type Fibre Grip D5618C.

### EXAMPLE 1

A number of 7 monolayers were woven in a plane weave structure from the tapes of the above, and stacked on top of each other in a cross-plied manner. The stack was subsequently pressed at 120 bar at 80″C for 30 minutes to form a 1 mm thick, 168 g/m2 consolidated sheet. The sheet was free of any matrix or binder. A surface of said sheet was primed by spraying with MIL-P-53022C,

Type II to yield a 2.0-4.0 μm wet primer layer which was subsequently dried hard for 30 minutes under 77° F., 50% humidity conditions. The primed dried layer had a thickness of about 1.0-2.0 μm. The primed surface was then cleaned from contamination and coated by spraying with MIL-PRF-22750 Topcoat, Color #17925 Insignia White or RAL 9016 to yield a 2.8-3.1 μm wet coating layer which was subsequently dried hard for 8 hours under 77° F., 50% humidity conditions. The coating dried layer had a thickness of about 1.8-2.0 μm and was cured for 7 days under the same conditions during coating.

A water jet cut equipment was used to shape and prepare the material for assembly on an antenna system. The edges of the mounted shaped material were sealed with silicone rubber to prevent moisture rooting and water absorption.

The dielectric loss was measured for an operational band of between 3 GHz and 9 GHz using a 30 Beam radar equipment from Folded Parallel Antenna with the following parameters:
Intensity 1.5 dB-4.5 dB
RF Power Handling 1 Watt
Switching Speed˜50 nS
Instantaneous Bandwidth—1.5 octaves
Field of view ±45 ° Azimuth
Dimensions for the unit holding the antenna were: 380 mm (wide)×435 mm (high)×195 mm (deep)

The measured dielectric loss was 0.0001.

### EXAMPLE 2

Example 1 was repeated, however an operational band of between 9 GHz and 18 GHz was used. The measured dielectric loss was 0.0001.

### Comparative Experiment

Example 1 was repeated, the sheet was neither primed nor coated. The measured dielectric loss was above 0.0002.

1. A low dielectric loss material comprising a plurality of polyolefin tapes forming a sheet and a coating disposed onto said sheet, wherein said coating comprises an epoxy resin

2. The material of claim 1 wherein said plurality of polyolefin tapes comprises at least one woven layer of tapes.

3. The material of claim 1 wherein the polyolefin tapes comprise ultra high molecular weight polyethylene tapes.

4. The material of claim 1 wherein the tensile strength of the polyolefin tapes is at least 0.3 GPa.

5. The material of claim 1 wherein said sheet is a multilayered sheet comprising a plurality of monolayers containing tapes.

6. The material of claim 1 wherein said sheet is free of any matrix or binder.

7. The material of claim 1 wherein said sheet is a consolidated sheet.

8. A low dielectric loss material comprising a plurality of polyolefin tapes forming a sheet, said sheet containing at least one primed surface, said at least one primed surface being primed with a primer comprising a thermosetting resin, wherein a coating is disposed onto said primed surface of said sheet, wherein said coating comprises an epoxy resin.

9. The material of claim 5 wherein the primer is a one-component aqueous adhesive primer which contains little or no volatile organic compounds.

10. An assembly comprising a high frequency antenna emitting and/or receiving a high frequency electromagnetic radiation and an antenna housing comprising walls and an opening to allow at least part of the electromagnetic radiation to be received and/or emitted by said antenna without interference with said walls wherein said opening is at least partially covered by the material of claim 1.
